(19) United States
(12) Patent Application Publication
(10) Pub. No.: US 2012/0082039 A1
(43) Pub. Date: Apr. 5, 2012

(54) METHODS AND APPARATUS FOR PROVIDING DIRECTIONAL INFORMATION FOR PEER DISCOVERY IN PEER-TO-PEER WIRELESS NETWORKS

(75) Inventors: Junyi Li, Chester, NJ (US); Vincent D. Park, Budd Lake, NJ (US); Mathew Scott Corson, Gillette, NJ (US)

(73) Assignee: QUALCOMM Incorporated, San Diego, CA (US)

(21) Appl. No.: 12/897,114

(22) Filed: Oct. 4, 2010

(51) Int. Cl. H04L 12/26

(52) U.S. Cl. 370/252

(57) ABSTRACT

Methods and apparatus for operating a local device to discover proximal information is disclosed. The method includes receiving a signal from a remote device, determining an identification and a relative bearing of the remote device based on the signal and displaying the identification and the relative bearing of the remote device. The apparatus for operating a local device to discover proximal information includes a processor configured to receive a signal from a remote device and determine an identification and a relative bearing of the remote device based on the signal and a display coupled to the processor, the display configured to display the identification and the relative bearing of the remote device.

### BACKGROUND

1. Field

The invention relates to wireless communications. More particularly, the invention relates to methods and apparatus for providing directional information for peer discovery in peer-to-peer wireless networks.

2. Background

Wireless communications continues to grow in demand and has become an integral part of both personal and business communications. Wireless communications allow users to transmit and receive data from most anywhere using wireless networks and wireless devices such as laptops, cellular devices, iPhones®, BlackBerrys®, etc.

Wireless fidelity (WiFi) describes the wireless networks that adhere to the specifications developed by the Institute of Electrical and Electronic Engineers (IEEE) for wireless local area networks (LAN). WiFi devices are certified to be interoperable with other certified WiFi devices using the 802.11 standard of the IEEE. These WiFi devices allow over-the-air interfaces in order to create a wireless network for facilitating data transfer.

Generally, wireless networks are established through mobile devices communicating with one or more base stations, access points or access routers. A base station is a radio receiver/transmitter that serves as a hub for wireless networks. A base station typically includes a low-power transmitter and a wireless router. An access router may be configured as an access point that covers a geographic range or cell and, as the mobile device is operated, it may move in and out of these geographic cells.

Some wireless networks can be constructed utilizing solely peer-to-peer communications without utilizing base stations, access points, or access routers. Such wireless networks are sometimes referred to as WiFi networks. Communications in such networks may, in some cases, be limited to exchanges between mobile devices that are within direct wireless transmission range of each other, while in other cases multi-hop forwarding between non-adjacent mobile devices may be supported. Various techniques may be used to maintain connectivity and/or forward information as the topology of the wireless network changes (e.g., as mobile devices join the network, leave the network, or move within the network). Some networks can also be constructed utilizing a combination of peer-to-peer communications as well as communications with base stations, access points, or access routers.

As mobile devices move in and out of wireless networks, the potential for higher layer communications with other mobile devices may be determined based on a process of peer discovery. To enable peer discovery, information associated with a mobile device (e.g., identifier, how to establish communications, and so forth) is advertised or announced (e.g., broadcast) to other mobile devices within a range. In a wireless network, peer nodes or devices discover each other by periodically transmitting and detecting peer discovery signals, which carry unique node identifiers (IDs). For example, mobile devices may periodically broadcast their identities, services or other information in a discovery channel so that other devices nearby, e.g., in the neighborhood, can discover them over time.

As mobile device capabilities continue to improve, augmented reality (AR) is becoming a greater part of mobile commerce. AR is a term for a live direct or indirect view of a physical real-world environment whose elements are augmented by virtual computer-generated imagery. In short, AR allows digital information to be overlaid on top of real world images or video.

Therefore, it has been recognized by those skilled in the art that a need exists for methods and apparatus for discovery of entities and information used for AR to determine the direction and/or range of the discovered information for peer discovery in peer-to-peer wireless networks.

### SUMMARY

Methods and apparatus for operating a local device to discover proximal information is disclosed. The method includes receiving a signal from a remote device, determining an identification and a relative bearing of the remote device based on the signal and displaying the identification and the relative bearing of the remote device.

The apparatus for operating a local device to discover proximal information includes a processor configured to receive a signal from a remote device and determine an identification and a relative bearing of the remote device based on the signal and a display coupled to the processor, the display configured to display the identification and the relative bearing of the remote device.

### BRIEF DESCRIPTION OF THE DRAWINGS

The features, objects, and advantages of the invention will become more apparent from the detailed description set forth below when taken in conjunction with the drawings, wherein:

FIG. 1 is a block diagram of a network having a plurality of nodes where each node can provide directional information for peer discovery in accordance with an embodiment of the invention.

FIG. 2 is a block diagram of an exemplary node capable of determining the direction and/or range of the discovered information in accordance with an embodiment of the invention.

FIG. 3 is an exemplary peer discovery slot in accordance with an embodiment of the invention.

FIG. 4 is a flow diagram illustrating a method of operating the local device to discover proximal information using the network in accordance with an embodiment of the invention.

FIG. 5 is a block diagram illustrating exemplary components for the apparatus and the means for apparatus for operating the local device to discover proximal information using the network in accordance with an embodiment of the invention.

### DETAILED DESCRIPTION

Methods and apparatus that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

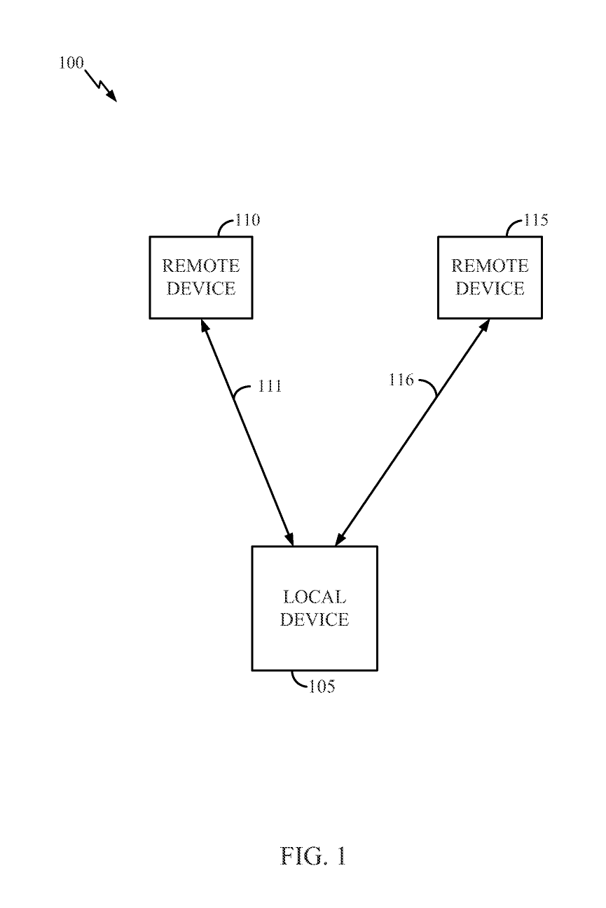

FIG. 1 is a simplified block diagram of a network 100 having a plurality of nodes 105, 110 and 115 where each node can provide directional information for peer discovery in accordance with an embodiment of the invention. The network 100 is configured to discover entities and information and determine the direction and/or range of the discovered information. In various embodiments, the network 100 can include one or more networks such as a WiFi network, an unlicensed network (i.e., a network operating in the unlicensed spectrum), a licensed network (i.e., a network operating in the licensed spectrum) and/or a carrier sense multiple access with collision avoidance (CSMA/CA) network, and each of the plurality of nodes 105, 110 and 115 can be a WiFi device or node, a mobile device, a peer or a wireless communications device configured to operate in the licensed spectrum and/or the unlicensed spectrum, a user, or a white-space device (WSD) configured to operate in the licensed spectrum and/or the unlicensed spectrum. A WSD can be a mobile device, a laptop computer or other portable device operating in open or unused frequencies. For illustrative purposes, the disclosure will discuss WiFi networks; however, other types of licensed and unlicensed networks are within the scope of the invention. Furthermore, even though three nodes 105, 110 and 115 are shown in FIG. 1, the network 100 can include one or more nodes. For illustrative purposes, nodes 105, 110 and 115 will also be referred to as local device 105, remote device 110 and remote device 115, respectively.

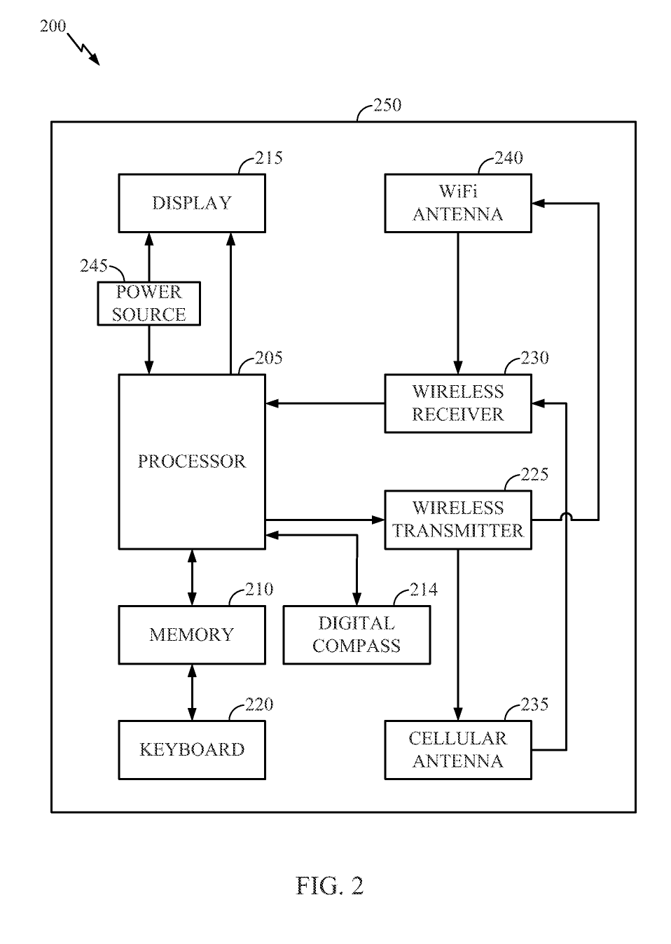

FIG. 2 is a block diagram of an exemplary node capable of determining the direction and/or range of the discovered information in accordance with an embodiment of the invention. For illustrative purposes, the term “device,” “node” or “peer” refers to a wireless communications device 200. The wireless communications device 200 is configured to communicate in the licensed spectrum and/or the unlicensed spectrum. The wireless communications device 200 includes a processor 205, a memory 210, a digital compass 214, a display 215, a keyboard 220, a wireless transmitter 225, a wireless receiver 230, a first antenna 235, a second antenna 240, and a power source 245 (e.g., a battery). The wireless communications device 200 can also include global positioning system (GPS) receivers, accelerometers, tilt sensors, cameras, and other components. The chips, components or modules may be attached or formed on a printed circuit board 250. The printed circuit board 250 can refer to any dielectric substrate, ceramic substrate, or other circuit carrying structure for carrying signal circuits and electronic components within the wireless communications device 200.

The processor 205 may be implemented using hardware, software, firmware, middleware, microcode, or any combination thereof. The processor 205 may be an Advanced RISC Machine (ARM), a controller, a digital signal processor (DSP), a microprocessor, an encoder, a decoder, circuitry, a processor chip, or any other device capable of processing data, and combinations thereof. The term “circuitry” may include processor circuitry, memory circuitry, RF transceiver circuitry, power circuitry, video circuitry, audio circuitry, keyboard circuitry, and display circuitry.

The memory 210 may include or store various routines and data. The term “memory” and “machine readable medium” include, but are not limited to, random access memory (RAM), flash memory, read-only memory (ROM), EPROM, EEPROM, registers, hard disk, removable disk, CD-ROM, DVD, wireless channels, and various other mediums capable of storing, containing or carrying instruction(s) and/or data. The machine readable instructions may be stored in the memory 210 and may be executed by the processor 205 to cause the processor 205 to perform various functions as described in this disclosure. The display 215 may be a LCD, LED or plasma display screen and the keyboard 220 may be a standard keyboard (e.g., a QWERTY layout) having letters and numbers.

The wireless transmitter 225 is coupled to the processor 205 and is used to encode and format the data for transmission via the first antenna 235 and/or the second antenna 240. The wireless transmitter 225 includes chips, circuitry and/or software that are used to transmit data and/or signals that are received from the processor 205 and prior to being sent to the first antenna 235 and/or the second antenna 240 for transmission over a channel. The wireless transmitter 225 may use information (e.g., an ID) received from other channels or nodes via the first antenna 235, the second antenna 240, and/or the processor 205 to create new data and/or signals for transmission to other nodes.

The wireless receiver 230 is coupled to the processor 205 and is used to decode and parse the data after being received from the first antenna 235 and/or the second antenna 240. The wireless receiver 230 includes chips, circuitry and/or software that are used to receive information (e.g., discovery signals or information) from other channels or nodes via the first antenna 235 and/or the second antenna 240. The information is sent to the processor 205 for decoding and processing of the data and/or signals that are to be transmitted to another node via the first antenna 235 and/or the second antenna 240.

The first antenna 235 may be positioned at a lower right portion of the wireless communications device 200 and the second antenna 240 may be positioned at an upper right portion of the wireless communications device 200. The first antenna 235 may be a cellular antenna, a GSM antenna, a CDMA antenna, a WCDMA antenna, a 3G antenna, a 4G antenna, or any other antenna capable of operating using the licensed spectrum. The second antenna 240 may be a WiFi antenna, a GPS antenna, or any other antenna capable of operating using the unlicensed spectrum. The power source 245 supplies power to the components or modules shown in FIG. 2. For illustrative purposes, each device shown in FIG. 1 can be a wireless communications device 200 as shown in FIG. 2.

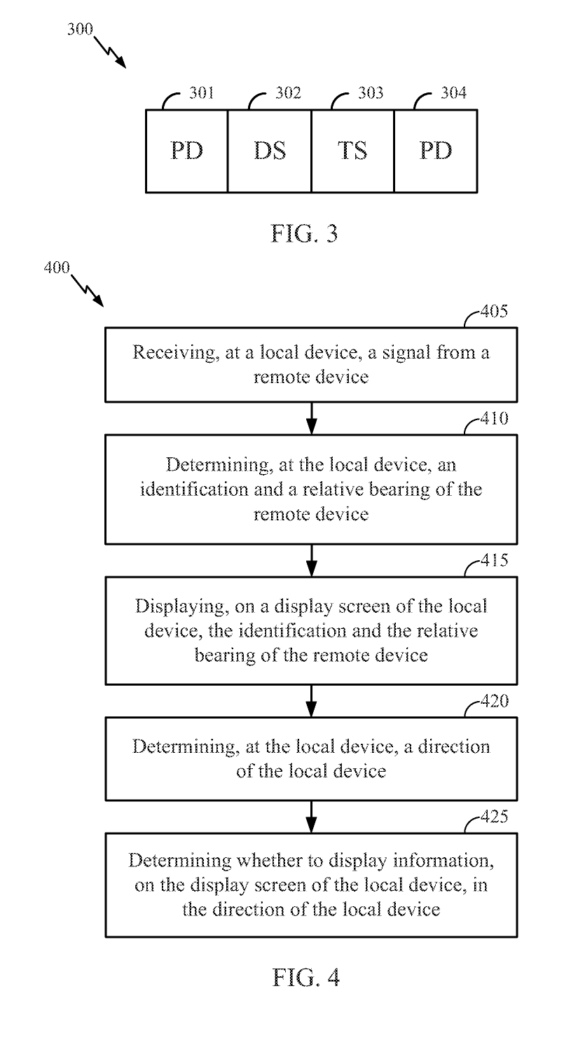

FIG. 3 is an exemplary peer discovery slot in accordance with an embodiment of the invention. The peer discovery slot 300 may include peer discovery (PD) 301, discovery service (DS) 302, time synchronization (TS) 303, and then peer discovery (PD) 304 again. During the peer discovery slot 300, each node listens and transmits so each node knows which local ID it is suppose to occupy and knows where to transmit. Therefore, the node can receive and decode other nodes' peer discovery information. As an example, the local device 105 advertises its presence by broadcasting peer discovery information throughout the wireless network 100. The remote devices 110 and 115 may receive the peer discovery information and may respond back to the local device 105.

FIG. 4 is a flow diagram illustrating a method 400 of operating the local device 105 to discover proximal information using the network 100 in accordance with an embodiment of the invention. The method 400 can determine a relative bearing of the local device 105, for example, based on signals or information received from one or more remote devices 110 and 115. The proximal information may be discovered information in the neighborhood or proximity of the local device 105 such as an architectural work, a building, an entity, an object, a person, a store, or other types of information or objects. The proximal information can be downloaded to the local device 105 using a wireless wide area network (WAN). For example, the local device 105 transmits its current GPS information to a server that contains or has access to updated proximal information and receives the relevant proximal information, which is stored in the memory 210 of the local device 105. Alternatively, the local device 105 can obtain the proximal information using peer-to-peer communications in which the local device 105 obtains the proximal information directly from, via wireless ad hoc connectivity, other remote devices 110 and 115 that are or were in the neighborhood of the local device 105. The wireless ad hoc connectivity can be based on Bluetooth, FlashLinQ, WAN, WiFi or other technologies. Also, the local device 105 can send queries to the remote devices 110 and 115, who can accordingly respond with the proximal information. Peer-to-peer communications for the discovery of proximal information used for AR can be extended to determine the direction and/or range of the proximal information.

Referring to FIGS. 1-4, the local device 105 can determine the direction and range of the discovered information received from the remote device 110 or 115 in a number of different ways. As an example, the local device 105 can have two antennas 235 and 240 to determine real-time direction and range data corresponding to the discovered information. The local device 105, using its plurality of antennas 235 and 240, receives a signal 111 from the remote device 110 (block 405). The two receive antennas 235 and 240 can estimate the angle of arrival of the signal 111 from the discovered remote device 110. The signal 111 may include location information of the remote device 110. As an example, the signal 111 may include digital data (e.g., bits) representing the location information of the remote device 110. The local device 105 may also know its current location information using GPS technology.

Once the signal 111 is received by the local device 105, the local device 105 discovers the presence of the remote device 110. The local device 105 determines an identification and a relative bearing of the remote device 110 based on the signal 111 (block 410). The relative bearing of the remote device 110 may be determined by the local device 105 using its plurality of antennas 235 and 240.

Thereafter, the local device 105 displays on its display 215, the identification and the relative bearing of the remote device 110 (block 415). The relative bearing can be associated with the orientation of the local device 105 (e.g., the direction in which the local device 105 or a camera of the local device 105 is pointing) such that the proximal information is displayed in a meaningful manner based on the orientation of the local device 105. The local device 105 may also display on its display 215, a range to the proximal information. The local device 105 may include a device capable of providing geolocation capabilities for determining the orientation of the local device 105 relative to magnetic north or true north reference(s). This allows the proximal information to be additionally displayed in a geographically relevant manner (e.g., on a map).

In one embodiment, the relative bearing may be an arrow, pointer or indicator, displayed on the display 215, pointing in the direction of the remote device 110. The relative bearing may also be placed on a map, which is displayed on the display 215. As the local device 105 is moved by the user, the relative bearing may also move to point in the direction that the user is pointing the local device 105. Therefore, the local device 105 displays proximal information on the display 215 relative to or in the direction that the user is pointing the local device 105. Prior to displaying the proximal information on the display 215, the local device 105 may also determine whether or not to display the proximal information which may be based on or a function of the orientation of the local device 105. For example, if the local device 105 is no longer pointing in the direction of the proximal information, the local device 105 will not display the proximal information.

The local device 105 determines a direction that it is pointing in (block 420). For example, the local device 105 may be equipped with a digital compass 214 to allow the local device 105 to know which direction the user is pointing the local device 105. The digital compass 214 may be a magnetic compass, sensor or global positioning system (GPS) information capable of determining the direction of the local device 105. Alternatively, the direction of the local device 105 is determined using the location information of the remote device 110 and the location information of the local device 105. The signal 111 from the remote device 110 to the local device 105 includes the location (e.g., geolocation) information of the remote device 110. The local device 105 compares the location information from the remote device 110 to its own location information to determine the relative bearing of the remote device 110. Hence, the local device 105 determines its own location information (e.g., current position or pointing direction) using, for example, the digital compass 214. The local device 105 may also display information on its display 215 in the direction of the local device 105 (block 425). The location information allows for display of the proximal information in a geographically relevant manner. These different techniques of providing geographically relevant information can be combined with determining the relative bearing and range of the remote device 110 to display the proximal information on the display 215 in a geographically relevant manner.

With respect to AR, the relative bearing and/or range information, as determined from the reception of discovered information broadcast from remote devices 110 and 115 (e.g., signals 111 and 116) in the local area of the local device 105, can be used to assist in the display of the AR information. For example, when attempting to augment an image using AR, not only is it possible to augment the image with discovered information, but the relative bearing and range to the remote device 110 of specific discovered information can be used to assist in determining whether the specific discovered information is relevant for augmentation of the image. The relative bearing and/or range information, solely or in combination with other sensor information to provide geographic reference information, can be used to assist in narrowing the search for information used to augment and/or correlate the image.

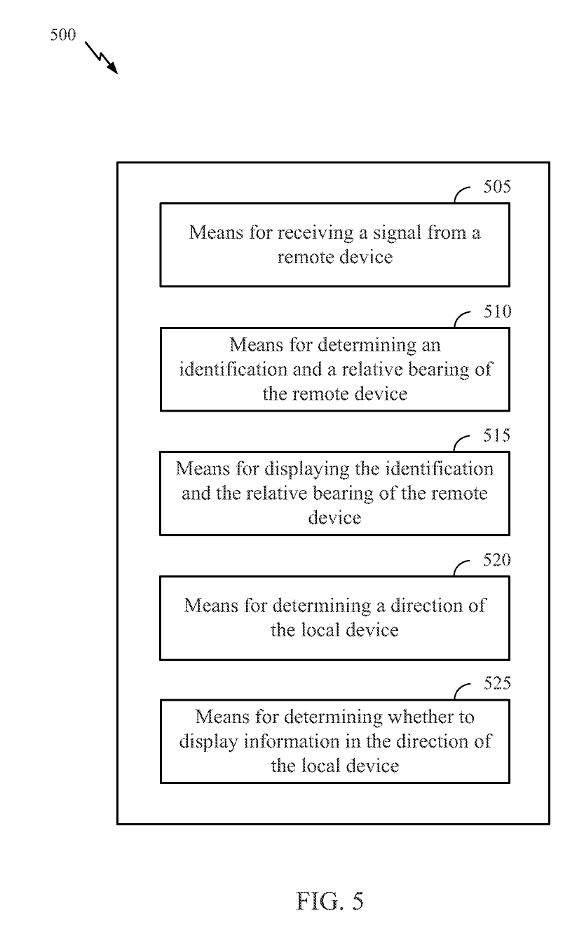

FIG. 5 is a block diagram illustrating exemplary components for the apparatus 500 and the means for apparatus 500 for operating the local device 105 to discover proximal information using the network 100 in accordance with an embodiment of the invention. The apparatus 500 may include a module 1005 for receiving a signal 111 from a remote device 110, a module 510 for determining an identification and a relative bearing of the remote device 110, a module 515 for displaying the identification and the relative bearing of the remote device 110, a module 520 for determining a direction of the local device 105, and a module 525 for determining whether to display information in the direction of the local device 105.

Those skilled in the art will appreciate that the various illustrative logical blocks, modules, circuits, and algorithms described in connection with the embodiments disclosed herein may be implemented as electronic hardware, computer software, or combinations of both. To illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein. A general purpose processing device may be a microprocessing device, but in the alternative, the processing device may be any conventional processing device, processing device, microprocessing device, or state machine. A processing device may also be implemented as a combination of computing devices, e.g., a combination of a DSP and a microprocessing device, a plurality of microprocessing devices, one or more microprocessing devices in conjunction with a DSP core or any other such configuration.

The apparatus, methods or algorithms described in connection with the embodiments disclosed herein may be embodied directly in hardware, software, or combination thereof. In software the methods or algorithms may be embodied in one or more instructions that may be executed by a processing device. The instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processing device such the processing device can read information from, and write information to, the storage medium. In the alternative, the storage medium may be integral to the processing device. The processing device and the storage medium may reside in an ASIC. The ASIC may reside in a user terminal. In the alternative, the processing device and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method of operating a local device to discover proximal information, the method comprising:
receiving a signal from a remote device;
determining an identification and a relative bearing of the remote device based on the signal; and
displaying the identification and the relative bearing of the remote device.

2. The method of claim 1 further comprising determining a direction of the local device.

3. The method of claim 2 further comprising determining whether to display information in the direction of the local device.

4. The method of claim 2 wherein determining the direction of the local device is obtained from a digital compass coupled to the local device.

5. The method of claim 1 wherein the local device includes a plurality of antennas, which are used to determine the relative bearing of the remote device.

6. The method of claim 1 wherein the signal includes location information of the remote device.

7. The method of claim 6 wherein the direction of the local device is determined using the location information of the remote device and location information of the local device.

8. An apparatus for operating a local device to discover proximal information, the apparatus comprising:
a processor configured to receive a signal from a remote device and determine an identification and a relative bearing of the remote device based on the signal; and
a display coupled to the processor, the display configured to display the identification and the relative bearing of the remote device.

9. The apparatus of claim 8 wherein the processor is further configured to determine a direction of the local device.

10. The apparatus of claim 9 wherein the processor is further configured to determine whether to display information in the direction of the local device.

11. The apparatus of claim 9 wherein the direction of the local device is obtained from a digital compass coupled to the local device.

12. The apparatus of claim 8 wherein the local device includes a plurality of antennas, which are used to determine the relative bearing of the remote device.

13. The apparatus of claim 8 wherein the signal includes location information of the remote device.

14. The apparatus of claim 13 wherein the direction of the local device is determined using the location information of the remote device and location information of the local device.

15. An apparatus for operating a local device to discover proximal information, the apparatus comprising:
means for receiving a signal from a remote device;
means for determining an identification and a relative bearing of the remote device based on the signal; and
means for displaying the identification and the relative bearing of the remote device.

16. The apparatus of claim 15 further comprising means for determining a direction of the local device.

17. The apparatus of claim 16 further comprising means for determining whether to display information in the direction of the local device.

18. The apparatus of claim 16 wherein the means for determining the direction of the local device is a digital compass coupled to the local device.

19. The apparatus of claim 15 wherein the local device includes a plurality of antennas, which are used to determine the relative bearing of the remote device.

20. The apparatus of claim 15 wherein the signal includes location information of the remote device.

21. The apparatus of claim 20 wherein the direction of the local device is determined using the location information of the remote device and location information of the local device.

22. A machine readable medium embodying machine executable instructions to implement a method of operating a local device to discover proximal information, the method comprising:
receiving a signal from a remote device;
determining an identification and a relative bearing of the remote device based on the signal; and
displaying the identification and the relative bearing of the remote device.

23. The method of claim 22 further comprising determining a direction of the local device.

24. The method of claim 23 further comprising determining whether to display information in the direction of the local device.

25. The method of claim 23 wherein determining the direction of the local device is obtained from a digital compass coupled to the local device.

26. The method of claim 22 wherein the local device includes a plurality of antennas, which are used to determine the relative bearing of the remote device.

27. The method of claim 22 wherein the signal includes location information of the remote device.

28. The method of claim 27 wherein the direction of the local device is determined using the location information of the remote device and location information of the local device.
